(19) United States
(12) Patent Application Publication
(10) Pub. No.: US 2009/0115773 A1
(43) Pub. Date: May 7, 2009

(54) COMPENSATION DEVICE, METHOD, AND ELECTRONIC SYSTEM UTILIZING THE SAME

(75) Inventor: Rong-Wha Wu, Yunlin County (TW)

Correspondence Address: QUINTERO LAW OFFICE, PC, 2210 MAIN STREET, SUITE 200, SANTA MONICA, CA, 90405, US

(73) Assignee: QISDA CORPORATION, Taoyuan County (TW)

(21) Appl. No.: 12/263,323

(22) Filed: Oct. 31, 2008

(30) Foreign Application Priority Data
Nov. 2, 2007 (TW) TW96141347

(51) Int. Cl. G09G 5/00

(52) U.S. Cl. 345/214

(57) ABSTRACT

A compensation device receiving an input signal, generating a compensated signal to a display panel, and including a memory unit and a control unit. The memory unit stores a first overdrive look-up table and a second overdrive look-up table. The control unit is connected to the memory unit and selects a compensation data from the first or the second overdrive look-up table according to a frame rate of the input signal. The control unit compensates the input signal by the compensation data to generate the compensated signal.

### BACKGROUND OF THE INVENTION

1. Field of the Invention

The invention relates to a compensation device, and more particularly to a compensation device providing different overdrive signals.

2. Description of the Related Art

Liquid crystal displays (LCDS) are widely used in mobile electronic products and flat televisions as they possess the favorable advantages of having a thin profile, light weight, and low power consumption. Each of LCDs comprises a driving integrated circuit (IC). The driving IC comprises a gate driver and a source driver. Taking an 8 bits source driver as an example, the source driver is capable of providing 256 gray levels to the liquid crystal molecule of the LCD. FIG. 1A is a schematic diagram of gray levels. At a time point t1, the gray level of the liquid crystal molecule is 40. At a time point t2, the gray level of the liquid crystal molecule is changed to 130. When the frame rate of the LCD is higher, the rotational speed of the liquid crystal molecule is less than the required speed of the LCD.

To solve the above problem, the conventional method utilizes an overdrive method to compensate for the rotational speed of the liquid crystal molecule. FIG. 1B is a schematic diagram of the conventional compensation method. At a time point t4, the liquid crystal molecule receives a higher gray level (150). Thus, the rotational speed of the liquid crystal molecule is increased. At a time point t5, the liquid crystal molecule receives the normally gray level (130).

Since the difference between the time points t1 and t2 exceed the difference between the time points t3 and t5, the conventional method is capable of increasing the rotational speed of the liquid crystal molecule. However, the charge time of the liquid crystal molecule is different from the discharge time of the liquid crystal molecule. If the fixed overdrive value is utilized, the best compensation effect can not be arrived. In this case, the overdrive (OD) value is 20 (150−130).

### BRIEF SUMMARY OF THE INVENTION

Compensation devices are provided. An exemplary embodiment of a compensation device, which receives an input signal and generates a compensated signal to a display panel, comprises a memory unit and a control unit. The memory unit stores a first overdrive look-up table and a second overdrive look-up table. The control unit is connected to the memory unit and selects a compensation data from the first or the second overdrive look-up table according to a frame rate of the input signal. The control unit compensates the input signal by the compensation data to generate the compensated signal.

A compensation method is provided. An exemplary embodiment of a compensation method, which provides a compensated signal to a display panel, is described in the following. An input signal is received. A frame rate of the input signal is detected. A compensation data is selected from a first overdrive look-up table or a second overdrive look-up table according to the frame rate. The input signal is compensated by the compensation data to generate the compensated signal.

Electronic systems are also provided. An exemplary embodiment of an electronic system displays an image and comprises a display panel and a compensation device. The display panel displays the image according to a compensated signal. The compensation device receives an input signal, generates the compensated signal and comprises a memory unit and a control unit. The memory unit stores a first overdrive look-up table and a second overdrive look-up table. The control unit is connected to the memory unit and selects a compensation data from the first or the second overdrive look-up table according to a frame rate of the input signal. The control unit compensates the input signal by the compensation data to generate the compensated signal.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1A is a schematic diagram of gray levels;

FIG. 1B is a schematic diagram of a conventional compensation method;

FIG. 2A is a schematic diagram of an exemplary embodiment of an electronic system;

FIG. 2B is a schematic diagram of another exemplary embodiment of an electronic system;

FIG. 3A is a schematic diagram of an exemplary embodiment of the control unit;

FIG. 3B is a schematic diagram of another exemplary embodiment of the control unit; and

FIG. 4 is a flowchart of an exemplary embodiment of a compensation method.

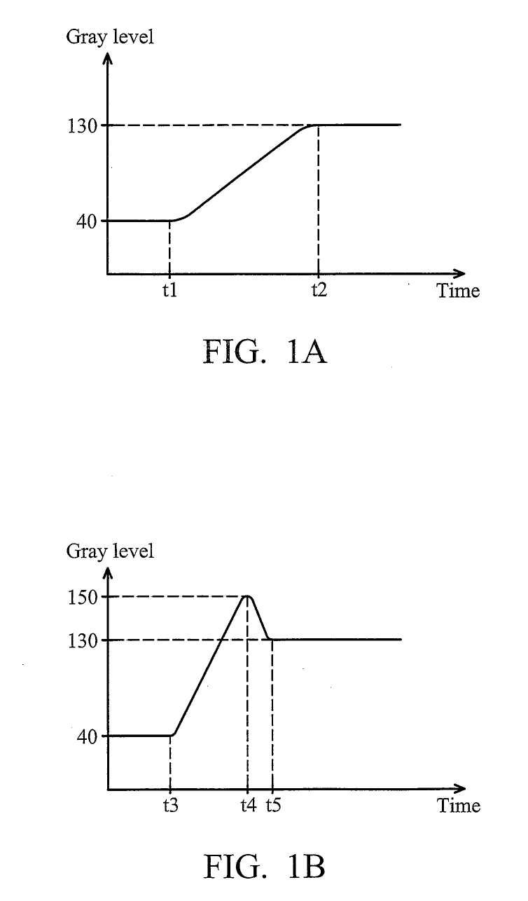

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

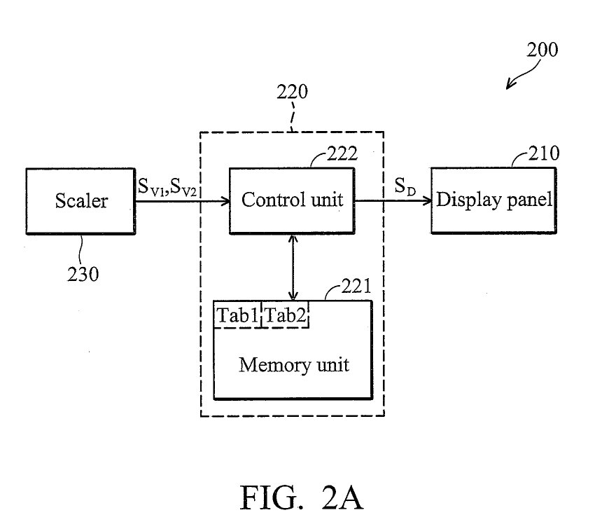

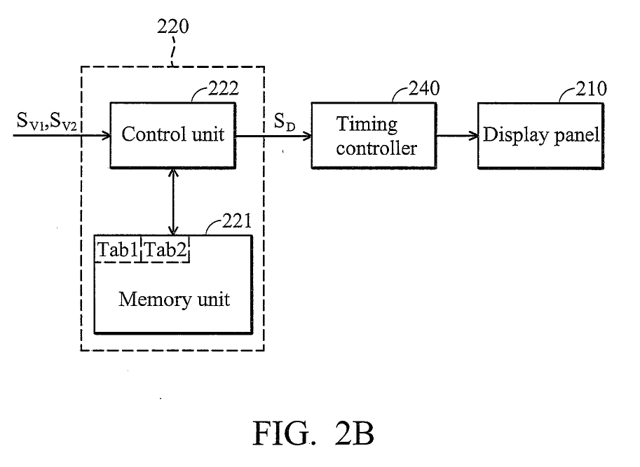

FIG. 2A is a schematic diagram of an exemplary embodiment of an electronic system. The electronic system 200 comprises a display panel 210 and a compensation device 220. The compensation device 220 receives an input signal including an image package S_{V1}, and generates a compensated signal S_{D}. The display panel 210 displays an image according to the compensated signal S_{D}.

In this embodiment, the compensation device 220 is a timing controller and receives the image package S_{V1} provided by a scaler 230. The display panel 210 displays the corresponding image according to the compensated signal S_{D} generated by the timing controller. FIG. 2B is a schematic diagram of another exemplary embodiment of an electronic system. In this embodiment, the compensation device 220 is a scaler. The scaler receives an input signal including an image package S_{V1} to generate a compensated signal S_{D} and provides the compensated signal S_{D} to a timing controller 240. The timing controller 240 controls the display panel 120 to display an image according to the compensated signal S_{D}.

Referring to FIG. 2A, the compensation device 220 comprises a memory unit 221 and a control unit 222. The memory unit 221 stores a first overdrive look-up table Tab1 and a second overdrive look-up table Tab2. In some embodiments, the memory unit 221 stores at least of three overdrive look-up table according to practical requirements. Generally, the look-up table may be modified in advance. Alternatively, and or additionally, the memory unit 221 stores a calculation formula. The calculation formula is capable of calculating the suitable overdrive signal according to the characteristic of the liquid crystal molecule.

The control unit 222 detects a frame rate of the image package S_{V1} of the input signal and utilizes the detection result to determine whether the first overdrive look-up table Tab1 or the second overdrive look-up table Tab2 should be a compensation look-up table. Then, the control unit 222 selects a compensation data from the compensation look-up table stored in the memory unit 221. The control unit 222 compensates the input signal with the compensation data to generate the compensated signal S_{D}. In this embodiment, the control unit 222 selects the compensation data from the first overdrive look-up table Tab1 when the frame rate of the image package S_{V1} is equal to a first rate, such as 60 Hz. The control unit 222 selects the compensation data from the second overdrive look-up table Tab2 when the frame rate of the image package S_{V1} is equal to a second rate, such as 75 Hz. The compensation data provided by the first overdrive look-up table Tab1 is more than or less than the compensation data provided by the second overdrive look-up table Tab2.

In one embodiment, the control unit 222 further detects the frame rate of an image package S_{V2} of the input signal. Assuming the image package S_{V1} comprises a first frame rate and the image package S_{V2} comprises a second frame rate. When the difference between the first and the second frame rates is less than a preset frequency, the control unit 222 selects a compensation data from the first overdrive look-up table Tab1. At this time, the first overdrive look-up table Tab1 is served as the compensation look-up table. The control unit 222 compensates the input signal according to the compensation data such that the compensated signal S_{D} is generated. When the difference between the first and the second frame rates exceeds the preset rate, the control unit 222 selects a compensation data from the second overdrive look-up table Tab2. At this time, the second overdrive look-up table Tab2 is served as the compensation look-up table. The control unit 222 compensates the input signal according to the compensation data such that the compensated signal S_{D} is generated.

In some embodiments, the control unit 222 detects the frame data of the image packages S_{V1} and S_{V2}. Assuming the image package S_{V1} comprises a first frame data and the image package S_{V2} comprises a second frame data. When the difference between the first and the second frame data is less than a preset value, the control unit 222 selects a compensation data from the first overdrive look-up table Tab1. The control unit 222 compensates the input signal according to the compensation data such that the compensated signal S_{D} is generated. When the difference between the first and the second frame data exceeds the preset value, the control unit 222 selects a compensation data from the second overdrive look-up table Tab2. The control unit 222 compensates the input signal according to the compensation data. Thus, the compensated signal S_{D} is generated.

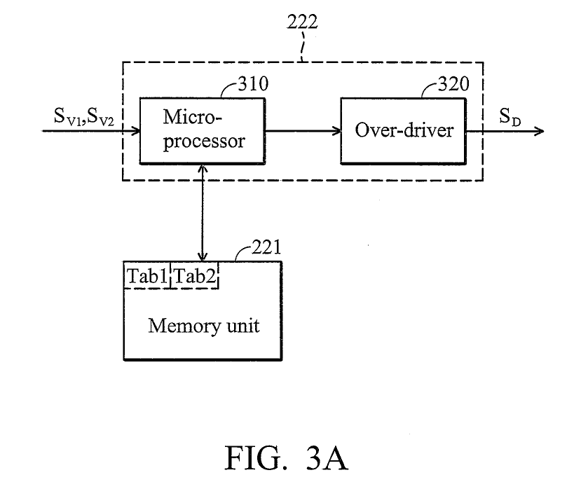

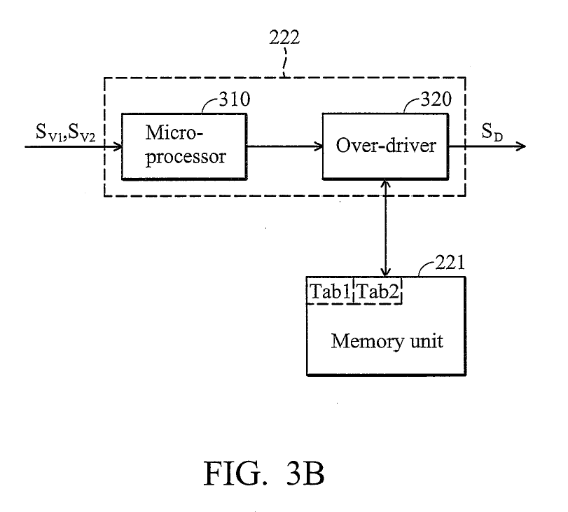

FIG. 3A is a schematic diagram of an exemplary embodiment of the control unit. The control unit 222 comprises a micro-processor 310 and an over-driver 320. The micro-processor 310 detects the image packages S_{V1} and S_{V2} and selectes a compensation data from the first overdrive look-up table Tab1 or the second overdrive look-up table Tab2 according to the detection result. The first and the second overdrive look-up tables are stored in the memory unit 221. The over-driver 320 generates the compensated signal S_{D} according to the compensation data.

FIG. 3B is a schematic diagram of another exemplary embodiment of the control unit. In this embodiment, the over-driver 320 selects a compensation data from the first overdrive look-up table Tab1 or the second overdrive look-up table Tab2 according to the detection result provided by the micro-processor 310. The over-driver 320 compensates the input signal according to the compensation data. Thus, the compensated signal S_{D} is generated and provided to the display panel 210. The first and the second overdrive look-up tables are stored in the memory unit 221. In some embodiments, the micro-processor 310, the over-driver 320, and the memory unit 221 are integrated into a chip.

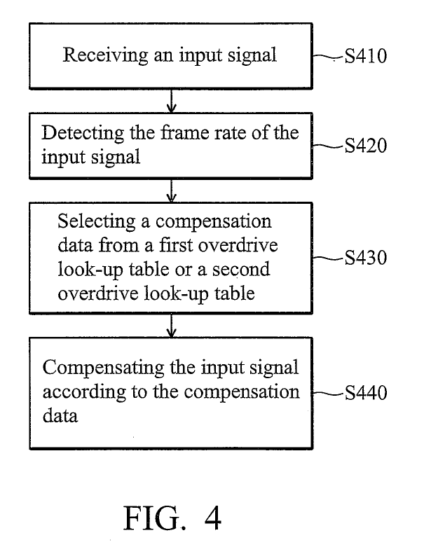

FIG. 4 is a flowchart of an exemplary embodiment of a compensation method. The compensation method provides a compensated signal to a display panel. First, an input signal is received (step S410). In one embodiment, the input signal comprises one or more image packages.

The frame rate of the input signal is detected (step S420). In one embodiment, a micro-processor is utilized to detect the frame rate or the frame data of the image package. A compensation data is selected from a first overdrive look-up table or a second overdrive look-up table according to the detection result (step S430). The input signal is compensated according to the compensation data such that the compensated signal is generated (step S440).

In one embodiment, when the frame rate of the image package is equal to a first frequency (60 Hz), the compensation data is selected from the first overdrive look-up table. When the frame rate of the received image package is equal to a second frequency (75 Hz), the compensation data is selected from the second overdrive look-up table.

In another embodiment, if the input signal comprises a plurality of image packages, the difference between the image packages is detected. For example, if the difference between the frame rates of two image packages is less than a preset frequency, the compensation data is selected from the first overdrive look-up table. If the difference between the frame rates of two image packages exceeds the preset frequency, the compensation data is selected from the second overdrive look-up table.

In some embodiment, the difference between the frame data of two image packages is detected. When the difference between the frame data of two image packages is less than a preset value, the compensation data is selected from the first overdrive look-up table. When the difference between the frame data of two image packages exceeds the preset value, the compensation data is selected from the second overdrive look-up table.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A compensation device receiving an input signal and generating a compensated signal to a display panel, the compensation device comprising:
a memory unit storing a first overdrive look-up table and a second overdrive look-up table; and
a control unit, connected to the memory unit and selecting a compensation data from the first or the second overdrive look-up table according to a frame rate of the input signal, wherein the control unit compensates the input signal by the compensation data to generate the compensated signal.

2. The compensation device as claimed in claim 1, wherein the control unit comprises:
a micro-processor detecting the frame rate of the input signal, and selecting the compensation data from the first or the second overdrive look-up table; and
an over-driver compensating the input signal with the compensation data to generate the compensated signal.

3. The compensation device as claimed in claim 1, wherein the control unit comprises:
a micro-processor detecting the frame rate of the input signal; and
an over-driver selecting the compensation data from the first or the second overdrive look-up table stored in the memory unit, and compensating the input signal with the compensation data to generate the compensated signal.

4. The compensation device as claimed in claim 1, wherein the control unit selects the compensation data from the first overdrive look-up table or the second overdrive look-up table when the frame rate of the input signal is equal to a first or second preset frequency.

5. The compensation device as claimed in claim 1, wherein the input signal comprises a first image package and a second image package, and the control unit further detects a first frame rate of a first image package and a second frame rate of a second image package, and the control unit selects the compensation data from the first overdrive look-up table for compensating the input signal when the difference between the first and the second frame rates is less than a preset frequency.

6. The compensation device as claimed in claim 1, wherein the control unit further detects a first frame data of the first image package and detects a second frame data of the second image package, and the control unit selects the compensation data from the first overdrive signal when the difference between the first and the second frame data is less than a preset value.

7. The compensation device as claimed in claim 1, wherein the compensation device is a scaler or a timing controller.

8. An electronic system for displaying an image, comprising:
a display panel displaying the image according to a compensated signal; and
a compensation device receiving an input signal, generating the compensated signal and comprising:
a memory unit storing a first overdrive look-up table and a second overdrive look-up table; and
a control unit, connected to the memory unit and selecting a compensation data from the first or the second overdrive look-up table according to a frame rate of the input signal, wherein the control unit compensates the input signal by the compensation data to generate the compensated signal.

9. The electronic system as claimed in claim 8, wherein the control unit comprises:
a micro-processor detecting the frame rate of the input signal, and selecting the compensation data from the first or the second overdrive look-up table; and
an over-driver compensating the input signal with the compensation data to generate the compensated signal.

10. The electronic system as claimed in claim 8, wherein the control unit comprises:
a micro-processor detecting the frame rate of the input signal; and
an over-driver selecting the compensation data from the first or the second overdrive look-up table stored in the memory unit and compensating the input signal by the compensation data to generate the compensated signal.

11. The electronic system as claimed in claim 8, wherein the control unit selects the compensation data from the first overdrive look-up table or the second overdrive look-up table when the frame rate of the input signal is equal to a first or second preset frequency.

12. The electronic system as claimed in claim 8, wherein the input signal comprises a first image package and a second image package, and the control unit further detects a first frame rate of a first image package and a second frame rate of a second image package, and the control unit selects the compensation data from the first overdrive look-up table for compensating the input signal when the difference between the first and the second frame rates is less than a preset frequency.

13. The electronic system as claimed in claim 8, wherein the control unit further detects a first frame data of the first image package and detects a second frame data of the second image package, and the control unit selects the compensation data from the first overdrive signal when the difference between the first and the second frame data is less than a preset value.

14. The electronic system as claimed in claim 8, wherein the compensation device is a scaler or a timing controller.

15. A compensation method providing a compensated signal to a display panel, comprising:
receiving an input signal;
detecting a frame rate of the input signal;
selecting a compensation data from a first overdrive look-up table or a second overdrive look-up table according to the frame rate; and
compensating the input signal by the compensation data to generate the compensated signal.

16. The compensation method as claimed in claim 15, wherein the input signal comprises a first image package, the first frame rate of the first image package is detected, and the compensation data is selected from the first overdrive look-up table or the second overdrive look-up table when the first frame rate is equal to a first or second preset frequency.

17. The compensation method as claimed in claim 15, wherein the input signal further comprises a second image package, the a second frame rate of the second image package is detected, and wherein the compensation data is selected from the first overdrive look-up table when the difference between the first and the second frame rates is less than a preset frequency.

18. The compensation method as claimed in claim 15, further comprising:
detecting a first frame data of the first image package; and
detecting a second frame data of the second image package.

19. The compensation method as claimed in claim 18, wherein the compensation data is selected from the first overdrive look-up table when the difference between the first and the second frame data is less than a preset value.
